(19) United States
(12) Patent Application Publication
(10) Pub. No.: US 2024/0308588 A1
(43) Pub. Date: Sep. 19, 2024

(54) MOTION MANAGER, VEHICLE CONTROL SYSTEM, AND VEHICLE CONTROL METHOD

(71) Applicant: TOYOTA JIDOSHA KABUSHIKI KAISHA, Toyota-shi (JP)

(72) Inventors: Hideki OHASHI, Chiryu-shi (JP); Wataru KANDA, Nisshin-shi (JP)

(73) Assignee: TOYOTA JIDOSHA KABUSHIKI KAISHA, Toyota-shi (JP)

(21) Appl. No.: 18/438,878

(22) Filed: Feb. 12, 2024

(30) Foreign Application Priority Data
Mar. 13, 2023 (JP) 2023-039014

(51) Int. Cl. B62D 15/02; B62D 6/00

(52) U.S. Cl. CPC B62D 15/0265; B62D 6/001

(57) ABSTRACT

A motion manager includes one or more processors. The one or more processors are configured to receive an action plan that includes information that indicates a control mode of a rear wheel steering device from a plurality of applications, are configured to arbitrate a plurality of the action plans by selecting an action plan of the application with a higher execution priority, and are configured to output the control mode that is included in an arbitrated action plan to the rear wheel steering device.

### CROSS-REFERENCE TO RELATED APPLICATION

This application claims priority to Japanese Patent Application No. 2023-039014 filed on Mar. 13, 2023, incorporated herein by reference in its entirety.

### BACKGROUND

### 1. Technical Field

The present disclosure relates to a motion manager, a vehicle control system, and a vehicle control method.

### 2. Description of Related Art

Japanese Unexamined Patent Application Publication No. 2020-32894 (JP 2020-32894 A) discloses a motion manager that, when receiving a request from an advanced safety application, outputs a command according to the request to a control unit of an actuator.

### SUMMARY

When a vehicle includes a rear wheel steering device that steers a rear wheel, the following process may be performed. That is, application-specific IDs are sent from a plurality of applications to a motion manager. Based on correspondence between the ID and a control mode of the rear wheel steering device, the motion manager may instruct a control mode that corresponds to the ID to the rear wheel steering device. In this case, when adding a new application, it is necessary to add the correspondence between the ID of the newly added application and the control mode of the rear wheel steering device to the motion manager. Therefore, when adding a new application, it is also necessary to update the motion manager.

A first aspect of the present disclosure is a motion manager that includes one or more processors. The one or more processors are configured to receive an action plan that includes information that indicates a control mode of a rear wheel steering device from a plurality of applications, are configured to arbitrate a plurality of the action plans by selecting an action plan of the application with a higher execution priority, and are configured to output the control mode that is included in an arbitrated action plan to the rear wheel steering device.

In the first aspect, the one or more processors may be configured to select an action plan of an application to avoid a vehicle collision as the highest priority action plan.

In the first aspect, the application may be an application that can be downloaded from an external server.

A second aspect of the present disclosure is a vehicle control system. The control system includes the motion manager and a plurality of the applications. The application is configured to send information that indicates the control mode of the rear wheel steering device to the motion manager.

A third aspect of the present disclosure is a vehicle control method caused by a computer mounted on the vehicle. The control method includes, by the computer, receiving an action plan that includes information that indicates a control mode of a rear wheel steering device from a plurality of applications, arbitrating a plurality of the action plans by selecting an action plan of the application with a higher execution priority, and outputting the control mode that is included in an arbitrated action plan to the rear wheel steering device.

According to the first aspect, the second aspect, and the third aspect of the present disclosure, there is no need to update the motion manager when adding a new application.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a functional block diagram that indicates a basic configuration of a motion manager; and

FIG. 3 is a diagram that illustrates an example of an operation for instructing a control mode of a rear wheel steering device.

### DETAILED DESCRIPTION OF EMBODIMENTS

### Schematic Configuration of Vehicle

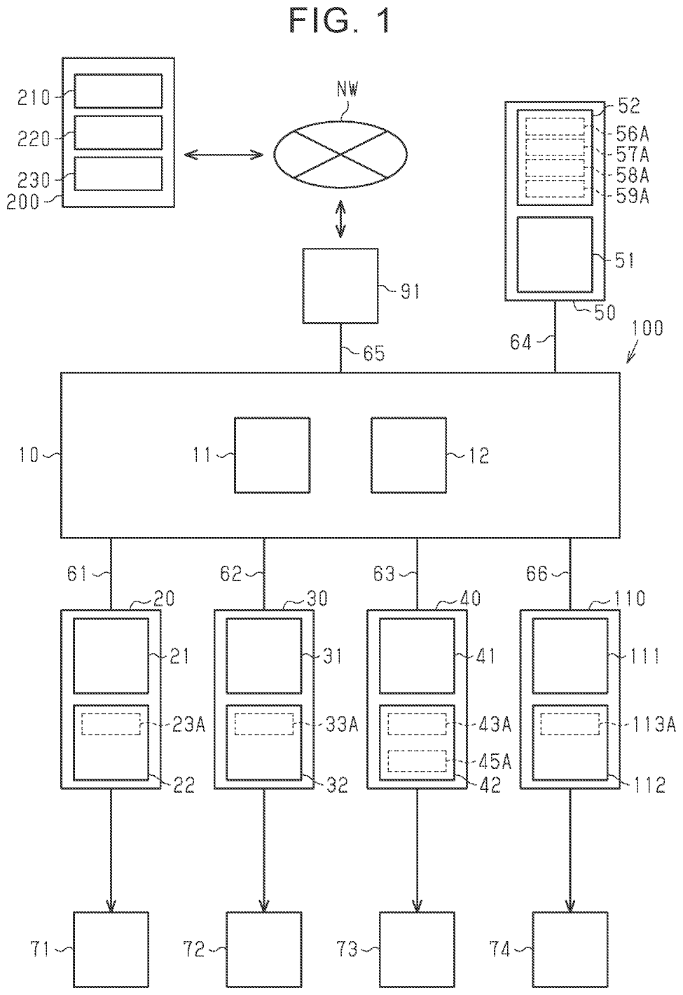

An embodiment of a motion manager, a vehicle control system, and a vehicle control method will be described below with reference to FIGS. 1 to 3. First, a schematic configuration of a vehicle 100 will be described.

As shown in FIG. 1, the vehicle 100 includes a powertrain device 71, a steering device 72, a brake device 73, and a rear wheel steering device 74. The powertrain device 71 includes an engine, a transmission, and the like. The engine can provide driving force to a driving wheel of the vehicle 100 via the transmission. An example of the steering device 72 is a rack and pinion electric steering device. The steering device 72 can change a direction of a steering wheel of the vehicle 100 by controlling a rack and pinion (not shown). The brake device 73 generates a braking force of the vehicle 100. The brake device 73 is a device that controls the braking force of the vehicle 100 by adjusting oil pressure. An example of the brake device 73 is a disc brake. The rear wheel steering device 74 is a device that steers a rear wheel of the vehicle 100.

As shown in FIG. 1, the vehicle 100 includes a central ECU 10, a powertrain ECU 20, a steering ECU 30, a brake ECU 40, a rear wheel steering ECU 110, and an advanced driving assistance ECU 50. Note that ECU is an abbreviation for an electronic control unit. The vehicle 100 also includes a first external bus 61, a second external bus 62, a third external bus 63, a fourth external bus 64, a fifth external bus 65, and a sixth external bus 66.

The central ECU 10 performs overall control of the entire vehicle 100. The central ECU 10 is a computer that includes a CPU 11 and a storage device 12. The storage device 12 stores various programs and various data in advance. Note that the storage device 12 includes ROM, RAM, and storage. The CPU 11 realizes various processes by executing the programs stored in the storage device 12. Note that CPU is an abbreviation for a central processing unit, ROM is an abbreviation for read only memory, and RAM is an abbreviation for random access memory.

The powertrain ECU 20 can communicate with the central ECU 10 via the first external bus 61. The powertrain ECU 20 controls the powertrain device 71 by outputting a control signal to the powertrain device 71. The powertrain ECU 20 is a computer that includes a CPU 21 and a storage device 22. The storage device 22 stores various programs and various data in advance. Furthermore, the storage device 22 stores in advance a powertrain application 23A as one of the various programs. The powertrain application 23A is application software that controls the powertrain device 71. Note that the storage device 22 includes ROM, RAM, and storage. The CPU 21 executes the powertrain application 23A that is stored in the storage device 22, thereby realizing a function as a powertrain control unit 23, which will be described later.

The steering ECU 30 can communicate with the central ECU 10 via the second external bus 62. The steering ECU 30 controls the steering device 72 by outputting a control signal to the steering device 72. The steering ECU 30 is a computer that includes a CPU 31 and a storage device 32. The storage device 32 stores various programs and various data in advance. Furthermore, the storage device 32 stores in advance a steering application 33A as one of the various programs. The steering application 33A is application software that controls the steering device 72. Note that the storage device 32 includes ROM, RAM, and storage. The CPU 31 executes the steering application 33A that is stored in the storage device 32, thereby realizing a function as a steering control unit 33, which will be described later.

The brake ECU 40 can communicate with the central ECU 10 via the third external bus 63. The brake ECU 40 controls the brake device 73 by outputting a control signal to the brake device 73. The brake ECU 40 is a computer that includes a CPU 41 and a storage device 42. The storage device 42 stores various programs and various data in advance. Furthermore, the storage device 42 stores in advance a brake application 43A as one of the various programs. The brake application 43A is application software that controls the brake device 73. Furthermore, the storage device 42 stores in advance a motion manager application 45A as one of the various programs. The motion manager application 45A is application software that arbitrates a plurality of motion requests. Note that the storage device 42 includes ROM, RAM, and storage. The CPU 41 executes the brake application 43A that is stored in the storage device 42, thereby realizing a function as a brake control unit 43, which will be described later. Furthermore, the CPU 41 executes the motion manager application 45A that is stored in the storage device 42, thereby realizing a function as a motion manager 45, which will be described later.

The rear wheel steering ECU 110 can communicate with the central ECU 10 via the sixth external bus 66. The rear wheel steering ECU 110 controls the rear wheel steering device 74 by outputting a control signal to the rear wheel steering device 74. The rear wheel steering ECU 110 is a computer that includes a CPU 111 and a storage device 112. The storage device 112 stores various programs and various data in advance. Furthermore, the storage device 112 stores in advance a rear wheel steering application 113A as one of the various programs. The rear wheel steering application 113A is application software that controls the rear wheel steering device 74. Note that the storage device 112 includes ROM, RAM, and storage. The CPU 111 executes the rear wheel steering application 113A that is stored in the storage device 112, thereby realizing a function as a rear wheel steering control unit 113, which will be described later.

The advanced driving assistance ECU 50 can communicate with the central ECU 10 via the fourth external bus 64. The advanced driving assistance ECU 50 executes various driving assistance. The advanced driving assistance ECU 50 is a computer that includes a CPU 51 and a storage device 52. The storage device 52 stores various programs and various data in advance. The various programs include a first assistance application 56A, a second assistance application 57A, a third assistance application 58A, and a fourth assistance application 59A. An example of the first assistance application 56A is application software for a collision mitigation brake, or a so-called autonomous emergency braking (AEB), which automatically applies the brake to reduce damage caused by a collision to the vehicle 100. An example of the second assistance application 57A is application software for lane keeping assistance, or a so-called lane keeping assist system (LKA), which maintains the lane in which the vehicle 100 is traveling. An example of the third assistance application 58A is application software for following driving, or a so-called adaptive cruise control (ACC), in which the vehicle 100 follows a preceding vehicle of the vehicle 100 while maintaining an inter-vehicle distance between the vehicle 100 and the preceding vehicle. An example of the fourth assistance application 59A is application software for parking assistance that automatically parks the vehicle 100. In the present embodiment, each of the first assistance application 56A, the second assistance application 57A, the third assistance application 58A, and the fourth assistance application 59A is application software that realizes a driving assistance function of the vehicle 100. Note that the storage device 52 includes ROM, RAM, and storage. The CPU 51 executes the first assistance application 56A that is stored in the storage device 52, thereby realizing a function as a first assistance unit 56, which will be described later. Also, the CPU 51 executes the second assistance application 57A that is stored in the storage device 52, thereby realizing a function as a second assistance unit 57, which will be described later. Moreover, the CPU 51 executes the third assistance application 58A that is stored in the storage device 52, thereby realizing a function as a third assistance unit 58, which will be described later. Furthermore, the CPU 51 executes the fourth assistance application 59A that is stored in the storage device 52, thereby realizing a function as a fourth assistance unit 59, which will be described later.

As shown in FIG. 1, the vehicle 100 includes a DCM 91. The DCM 91 is connected to the central ECU 10 via the fifth external bus 65. The DCM 91 includes a communication function to perform wireless communication with equipment outside the vehicle 100 via a communication network NW. Note that DCM is an abbreviation for a data communication module.

The DCM 91 communicates with a data center 200 via the communication network NW. An example of the data center 200 is a so-called external server. The data center 200 includes a CPU 210, a storage device 220, and a communication device 230. The communication device 230 can communicate with equipment outside the data center 200 via the communication network NW. A new assistance application downloaded from the data center 200 can be added to the storage device 52 of the advanced driving assistance ECU 50.

### Basic Configuration Related to Motion Manager

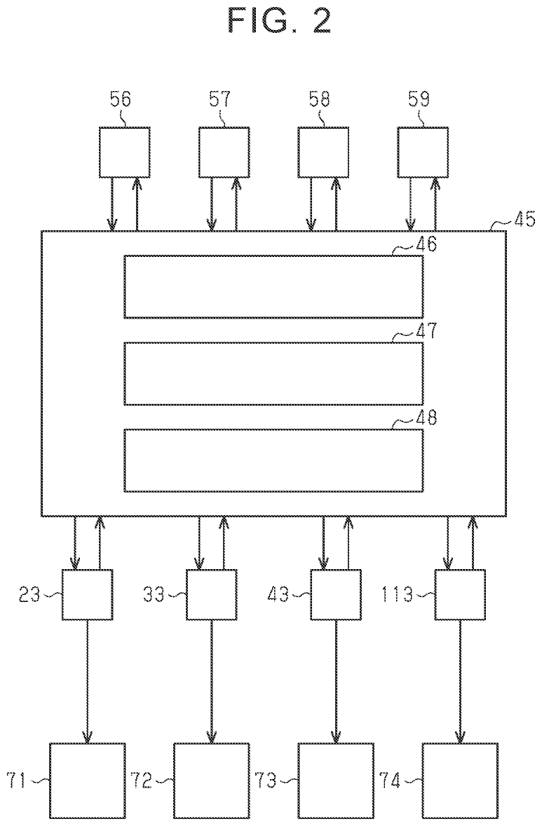

Next, a basic configuration related to the motion manager 45 will be explained with reference to FIG. 2. As shown in FIG. 2, the motion manager 45 can communicate among each other with the first assistance unit 56, the second assistance unit 57, the third assistance unit 58, and the fourth assistance unit 59. The motion manager 45 can also communicate among each other with the powertrain control unit 23, the steering control unit 33, the brake control unit 43, and the rear wheel steering control unit 113.

Each of the first assistance unit 56, the second assistance unit 57, the third assistance unit 58, and the fourth assistance unit 59 outputs an action plan to the motion manager 45 when various controls are executed. At this time, the first assistance unit 56, the second assistance unit 57, the third assistance unit 58, and the fourth assistance unit 59 continue outputting the action plan from when various controls become necessary to when the controls are no longer necessary, for example.

The action plan includes a requested value of acceleration to control acceleration in a front-rear direction of the vehicle 100, a target curvature, a priority of an application to be executed, a control mode of the rear wheel steering device 74, and the like.

The control mode of the rear wheel steering device 74 is one of a zero degree mode RS0, a reverse phase mode RS1, and an in-phase mode RS2. The zero degree mode RS0 is a mode in which a steering angle of the rear wheel is set to zero degrees. The reverse phase mode RS1 is a mode in which the rear wheel of the vehicle 100 is steered in a direction opposite to the steering direction of a front wheel of the vehicle 100. The in-phase mode RS2 is a mode in which the rear wheel of the vehicle 100 is steered in a same direction as the steering direction of the front wheel of the vehicle 100.

The priority of the application to be executed includes, in order from high to low priority, a collision avoidance application with high urgency, an unmanned premise application, a driving assistance application such as LKA, and the like. An example of the collision avoidance application is AEB and the like. An example of the unmanned premise application is parking assistance and the like. An example of the driving assistance application is LKA and the like. Note that the control mode of the rear wheel steering device 74 in the AEB action plan is the zero degree mode RS0. Note that the control mode of the rear wheel steering device 74 in the parking assistance action plan is the reverse phase mode RS1. Note that the control mode of the rear wheel steering device 74 in the LKA action plan is the in-phase mode RS2.

As shown in FIG. 2, the motion manager 45 includes a reception unit 46, an arbitration unit 47, and an output unit 48. The reception unit 46 receives action plans from the first assistance unit 56, the second assistance unit 57, the third assistance unit 58, and the fourth assistance unit 59. In the present embodiment, receiving the action plans from the first assistance unit 56, the second assistance unit 57, the third assistance unit 58, and the fourth assistance unit 59 corresponds to receiving an action plan from the application software.

The arbitration unit 47 arbitrates the action plan received by the reception unit 46. An example of a process of this arbitration is to select one action plan from a plurality of action plans based on a predetermined selection criterion. For example, the arbitration unit 47 selects the action plan of the application with the highest priority among the applications to be executed. This selected action plan includes the acceleration requested to the vehicle 100 and a control mode RSn (n is zero, one, or two) of the rear wheel steering device 74 included in the action plan.

The output unit 48 outputs an instruction value of the motion request to control various actuators based on an arbitration result. Here, the various actuators include the powertrain device 71, the steering device 72, the brake device 73, the rear wheel steering device 74, and the like. For example, when controlling the powertrain device 71, the output unit 48 of the motion manager 45 outputs the instruction value of the motion request to the powertrain control unit 23. Then, the powertrain control unit 23 outputs the control signal to the powertrain device 71 based on the instruction value of the motion request. Further, for example, when controlling the rear wheel steering device 74, the output unit 48 of the motion manager 45 outputs the selected control mode RSn, the steering angle of the rear wheel, and the like to the rear wheel steering control unit 113 as the instruction values of the motion requests. Then, the rear wheel steering control unit 113 outputs the control signal to the rear wheel steering device 74 based on these instruction values of the motion requests. In this way, the instruction value output by the output unit 48 is received by the control unit corresponding to the actuator to be controlled, and the actuator is controlled by the control unit. The motion manager 45 similarly outputs instruction values to the steering control unit 33 and the brake control unit 43.

### Actions

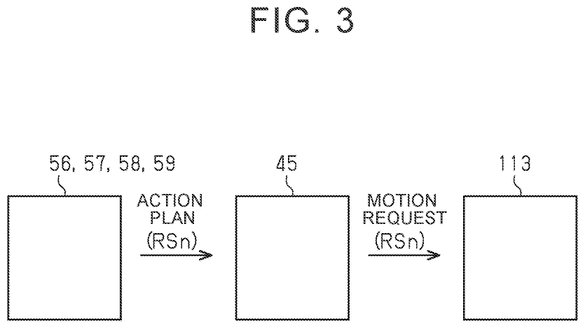

Actions of the present embodiment will be described. As shown in FIG. 3, the first assistance unit 56, the second assistance unit 57, the third assistance unit 58, and the fourth assistance unit 59 send the action plans that include the control mode RSn of the rear wheel steering device 74 to the motion manager 45. The motion manager 45 selects one action plan from a plurality of action plans based on a predetermined selection criterion. As the predetermined selection criterion in the present embodiment, for example, the motion manager 45 selects the action plan of the application with the highest priority among the applications to be executed. Then, the motion manager 45 sends the control mode RSn of the rear wheel steering device 74 that is included in the selected action plan to the rear wheel steering control unit 113. The rear wheel steering control unit 113 that has received the control mode RSn controls the rear wheel steering device 74 so as to realize the received control mode RSn.

### Effects

Effects of the present embodiment will be described. The action plan received from each application by the reception unit 46 of the motion manager 45 includes information that indicates the control mode RSn of the rear wheel steering device 74. Therefore, the motion manager 45 does not need to be provided in advance with a correspondence between an application-specific ID and the control mode RSn of the rear wheel steering device 74. Thus, when adding a new application, there is no need to update the motion manager 45.

### MODIFICATIONS

The present embodiment can be realized with the following modifications. The present embodiment and the following modifications can be combined with each other within a technically consistent range to be realized.

Although the arbitration unit 47 selects the action plan of the application to avoid a vehicle collision as the action plan of the application with a higher execution priority, it may select the action plan of another application.

The application may be an application that can be installed from a storage medium such as a secure digital (SD) card or universal serial bus (USB) memory. The ECU that realizes the function of the motion manager 45 may be an ECU other than the brake ECU 40. As a specific example, instead of the brake ECU 40, the CPU 11 of the central ECU 10 may realize the function of the motion manager 45 by executing the motion manager application 45A stored in the storage device 12. That is, the function of the motion manager 45 may be realized by any one of the central ECU 10, the powertrain ECU 20, the steering ECU 30, the brake ECU 40, the advanced driving assistance ECU 50, and the rear wheel steering ECU 110.

What is claimed is:

1. A motion manager comprising one or more processors configured to:
receive an action plan that includes information indicating a control mode of a rear wheel steering device from a plurality of applications;
arbitrate a plurality of the action plans by selecting an action plan of the application with a higher execution priority; and
output the control mode that is included in an arbitrated action plan to the rear wheel steering device.

2. The motion manager according to claim 1, wherein the one or more processors are configured to select an action plan of an application to avoid a vehicle collision as an action plan having the highest priority.

3. The motion manager according to claim 1, wherein the application is an application that is downloadable from an external server.

4. A vehicle control system comprising:
the motion manager according to claim 1; and
a plurality of the applications, wherein the application is configured to send information indicating the control mode of the rear wheel steering device to the motion manager.

5. A vehicle control method executed by a computer mounted on a vehicle, the vehicle control method comprising:
receiving, by the computer, an action plan that includes information indicating a control mode of a rear wheel steering device from a plurality of applications;
arbitrating, by the computer, a plurality of the action plans by selecting an action plan of the application with a higher execution priority; and
outputting, by the computer, the control mode that is included in an arbitrated action plan to the rear wheel steering device.
